(19) United States
(12) Patent Application Publication
(10) Pub. No.: US 2014/0335337 A1
(43) Pub. Date: Nov. 13, 2014

(54) HIGH STRENGTH TRANSPARENT PLASTIC SHEET FOR SUBSTITUTING GLASS SUBSTRATE AND METHOD OF MANUFACTURING THE SAME

(71) Applicant: LG HAUSYS, LTD., Yeongdeungpo-gu Seoul (KR)

(72) Inventors: Eung Kee Lee, Anyang-si (KR); Min Hee Lee, Gunpo-si (KR); Chang Hak Shin, Seoul (KR); Ku Il Park, Yongin-si (KR)

(21) Appl. No.: 14/361,064

(22) PCT Filed: Dec. 6, 2012
(86) PCT No.: PCT/KR2012/010531

§ 371 Date: May 28, 2014

(30) Foreign Application Priority Data
Dec. 16, 2011 (KR) 10-2011-0136179

(51) Int. Cl. B32B 7/12; B32B 37/02; B32B 37/12; B32B 7/02; B32B 27/08

(52) U.S. Cl. CPC B32B 7/12; B32B 7/02; B32B 27/08; B32B 37/1284; B32B 37/02; B32B 2307/558; B32B 2250/40; B32B 2255/26; B32B 2307/412; B32B 2307/536; B32B 2457/20; B32B 2333/12; B32B 2333/08; B32B 2307/306
USPC 428/214; 428/212; 428/216; 428/413; 428/423.7; 428/424.8; 428/447; 428/483; 156/280; 427/407.1

(57) ABSTRACT

A high strength transparent plastic sheet in accordance with the present invention comprises: a transparent substrate layer; a first and a second adhesive layers respectively formed on both sides of the transparent substrate layer; a first and a second heat-resistant resin layer respectively formed on an outer surface of the first and second coating layer; and a first and a second hard coating layer respectively formed on an outer surface of the first and second resin layer.

### TECHNICAL FIELD

The present invention relates to a high strength transparent plastic sheet for substituting glass substrate and method of manufacturing the same, and more particularly a high strength transparent plastic sheet for substituting glass substrate and method of manufacturing the same appropriate for use for outer windows of portable display devices.

### BACKGROUND ART

Transparent glass substrates used for portable display devices such as mobile phones, smart phones, PDA (personal digital assistants), tablet PC (tablet personal computer), etc. are mostly treated to be chemically reinforced, and show excellent physical properties in terms of impact strength, surface harness, and flexural modulus.

But, this transparent glass substrate has disadvantages of being priced at relatively high prices and considerably heavier than plastics, etc. Especially, light weight materials such as plastics are being introduced at a fast rate in respect to current trends of portable devices becoming lighter and slimmer.

For this reason, lately, sheets extruded to a single layer from polymethyl methacrylate (PMMA) resins are being used for outer windows of portable display devices in place of transparent glass substrates.

But, in the case of sheets using PMMA resins, there are problems of breaking even from small outside impact due to its low impact resistance.

Also, transparent sheets coextruded from polycarbonate (PC) resin and PMMA aimed at granting impact resistance are being used for outer windows of portable display devices.

But also in this case, due to low flexural modulus, when pressed with a finger, there are problems of outer windows being pressed and pushed inside.

### DISCLOSURE

### Technical Problem

The present invention is provided to solve the disadvantages of the transparent glass substrate and provide a functional high strength transparent plastic sheet which is a light weight material and also may be applied to outer windows of portable display devices.

Also, an objective of the present invention is to provide a high strength transparent plastic sheet having a surface hardness close to a surface hardness of a glass substrate, and physical properties resistant to high temperature and high humidity.

### Technical Solution

A high strength transparent plastic sheet for substituting glass substrate in accordance with an embodiment of the present invention to achieve the described objectives comprises: a transparent substrate layer; a first and a second adhesive layers respectively formed on both sides of the transparent substrate layer; a first and a second heat-resistant resin layers respectively formed on outer surfaces of the first and the second coating layers; and a first and a second hard coating layers respectively formed on outer surfaces of the first and the second resin layers.

A method for manufacturing high strength transparent plastic sheet for substituting glass substrate in accordance with an embodiment of the present invention to achieve the described objectives comprises: (a) attaching first and second adhesive layers and first and second resin layers in order respectively to a transparent substrate layer; and (b) forming first and second hard coating layers respectively on outer surfaces of the first and the second heat-resistant resin layers.

### Advantageous Effects

A high strength transparent plastic sheet in accordance with the present invention not only has benefits of having impact resistance and resistance to high temperature and high humidity, but also is relatively lighter and has remarkably low manufacturing costs compared to glass substrates.

Therefore, since it is possible for a high strength transparent plastic sheet in accordance with the present invention to possess excellent mechanical and optical physical properties while based on plastic materials, it is suitable for outer window applications of portable display devices such as mobile phones, smart phones, PDAs (personal digital assistants), tablet PCs (tablet personal computer), etc.

### DESCRIPTION OF DRAWINGS

FIG. 1 is a cross-sectional view illustrating a high strength transparent plastic sheet in accordance with an embodiment of the present invention.

FIG. 2 is a cross-sectional view illustrating a high strength transparent plastic sheet in accordance with another embodiment of the present invention.

FIG. 3 is a process flow chart illustrating a method for manufacturing high strength transparent plastic sheet in accordance with an embodiment of the present invention.

### BEST MODE

Advantages and features of the present invention, and method for achieving thereof will be apparent with reference to the accompanying figures and detailed description that follows. But, it should be understood that the present invention is not limited to the following embodiments and may be embodied in different ways, and that the embodiments are given to provide complete disclosure of the invention and to provide thorough understanding of the invention to those skilled in the art, and the scope of the invention is limited only by the accompanying claims and equivalents thereof. Like components will be denoted by like reference numerals throughout the specification

A high strength transparent plastic sheet for substituting glass substrate and method of manufacturing the same in accordance with a preferred embodiment of the present invention will be explained in more detail below with reference to the accompanying figures.

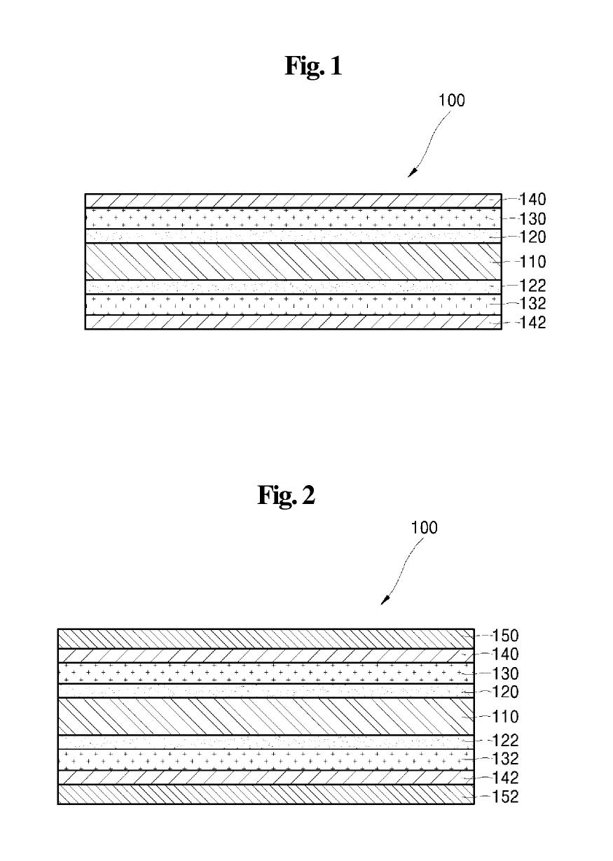

FIG. 1 is a cross-sectional view illustrating a high strength transparent plastic sheet in accordance with an embodiment of the present invention.

Referring to FIG. 1, illustrated high strength transparent plastic sheet (100) may comprise a transparent substrate layer (110), a first and a second adhesive layers (120, 122), a first and a second heat-resistant resin layers (130, 132), and a first and a second hard coating layers (140, 142).

A transparent substrate layer may have a thickness of about 0.03˜5 mm, but is not limited to this, and may be altered in a number of ways according to applied models.

This transparent substrate layer may comprise one or more elements selected from polyethylene terephthalate (PET), polyethylene terephthalate glycol (PETG), cyclo-olefin polymer (COP), cyclo-olefin copolymer (COC), and polyethylene naphthalate (PEN).

In this case, it is preferable to apply as a composite resin except for polyethylene terephthalate (PET) or polyethylene terephthalate glycol (PETG). This is because, in the case of polyethylene terephthalate (PET) or polyethylene terephthalate glycol (PETG), it possesses high elongation ratios while having constant strength even when used individually, and have effects of preventing faults such as cracks, etc. in curved surface sections beforehand by having flexible characteristics.

The first and the second adhesive layers (120, 122) should be formed between the transparent substrate layer (110) and the first heat-resistant resin layer (130), which is described below, and between the transparent substrate layer (110) and the second heat-resistant resin layer (132) respectively, and plays a role of improving adhesive strength of the first and the second heat-resistant resin layers (130, 132) and the transparent substrate layer (110). These first and second adhesive layers (120, 122) may be formed with the first and the second heat-resistant resin layers (130, 132) by a coextrusion coating process on the transparent substrate layer (110). On the other hand, the first and the second adhesive layers (120, 122) may be formed by means of a method coating in advance on a transparent substrate layer (110) through a pretreatment process.

These first and second adhesive layers (120, 122) may use adhesives selected from polyester, polyurethane, and ethylene co-vinyl acetate (EVA), polyvinyl acetate (PVAc). The first and the second adhesive layers (120, 122) may be formed by a method using one of the methods selected from gravure printing method, screen printing method and flexo printing method of roll-to-roll method, micro gravure coating, comma coating, roll coating, etc. and coating at an optimal thickness and drying.

It is more advantageous for the thickness of each of the first and the second adhesive layers (120, 122) to be thinner, but may be difficult to secure adhesive strengths above an optimal level when the thickness of each of the first and the second adhesive layers (120, 122) is less than 0.5 μm. On the contrary, in the case where the thickness of each of the first and the second adhesive layers (120, 122) is above 5 μm, strength of the product becomes weaker due to the increase in amount of adhesives used, and there are problems of heat-resistance. Therefore, forming each of the first and the second adhesive layers (120, 122) to the thickness of 0.5˜5 μm is preferable.

The first and the second heat-resistant resin layers (130, 132) each may be formed on both sides of the transparent substrate layer (110), to which the first and the second adhesive layers (120, 122) are coated beforehand, through an extrusion coating process, or may be formed through a coextrusion coating method with the first and the second adhesive layers (120,122). In this instance, it is preferable for each of the first and the second heat-resistant resin layers (130, 132) to have polymethyl methacrylate (PMMA) with weight-average molecular weight of 100,000˜200,000 as its main component, preferably using what is made of acrylic resin with glass transition temperature of 120˜130 degrees. When the acrylic resin with glass transition temperature below 120 degrees or with weight-average molecular weight of less than 100,000 is used for the first and the second heat-resistant resin layers (130, 132), problems of curling may occur in the printing process, which is performed in a relatively high temperature (about 70˜90° C.), for outer windows of portable display devices. On the contrary, when the acrylic resin with glass transition temperature is above 130 degrees or with weight-average molecular weight of more than 200,000 is used for the first and the second heat-resistant resin layers (130, 132), strength is improved, but optical birefringence may occur, and probability of curling problems occurring in the printing process increases due to the residual stress during cooling process.

The first and the second and hard coating layers (140, 142) are formed respectively on an outer surface of the first and the second heat-resistant resin layers (130, 132). These first and second and hard coating layers (140, 142) play a role of improving pollution-resistance, impact resistance, scratch resistance, etc., and as an example, may be formed by a gravure printing method.

In this instance, each of the first and the second hard coating layers (140, 142) may use at least one selected from acrylic, urethane, epoxy, and siloxane based polymeric materials, and also ultra violet ray curing resin such as an oligomer. Also, the first and the second hard coating layers (140, 142) may further comprise silica fillers to improve strength.

Forming each of the first and the second hard coating layers (140, 142) with thickness of 2˜7 μm is preferable. When the thickness of each of the first and the second hard coating layers (140, 142) is less than 2 μm, exhibiting the described effect may be difficult. On the contrary, when the thickness of each of the first and the second hard coating layers (140, 142) is greater than 7 μm, there are problems of having greater manufacturing costs compared to increase in effectiveness.

A high strength transparent plastic sheet in accordance with the present invention describe above not only has benefits of having impact resistance and resistance to high temperature and high humidity, but also is relatively lighter and has remarkably low manufacturing costs compared to glass substrates.

Therefore, since it is possible for a high strength transparent plastic sheet in accordance with the present invention to possess excellent mechanical and optical physical properties while based on plastic materials, it is suitable for outer window applications of portable display devices such as cellular phones, smart phones, PDA (personal digital assistants), tablet PC (tablet personal computer), etc.

FIG. 2 is a cross-sectional view illustrating a high strength transparent plastic sheet in accordance with another embodiment of the present invention.

Referring to FIG. 2, a high strength transparent plastic sheet (100) in accordance with another embodiment of the present invention have practically identical configuration of a high strength transparent plastic sheet (100 of FIG. 1) in accordance with an embodiment. However, a high strength transparent plastic sheet (100) in accordance with another embodiment of the present invention further comprises a first and a second protective films (150, 152) laminated respectively on the first and the second hard coating layers (140, 142).

The first and the second protective films (150, 152) are release films formed to protect sheet surfaces from dust, foreign objects, etc., and are used delaminated when used in outer windows of portable display devices.

These first and second protective films (150, 152) may use one or more elements selected from polyethylene resin, polyolefine resin, polybutylene terephthalate resin, polyethylene terephthalate resin, polyethylene naphthalate resin, polyetherimide resin, acetate resin, polystyrene resin, vinyl chloride resin, etc.

The thickness of these first and second protective films (150, 152) is not specifically limited, but is preferable to be formed between 20˜200 μm, and this is because when thickness of first and second protective films (150, 152) are too thin or thick, difficulty in handling arise, and especially, there are problems of manufacturing costs increasing excessively when thickness is thicker than 200 μm.

Hereinafter, a method for manufacturing high strength transparent plastic sheet for substituting glass substrates in accordance with an embodiment of the present invention in described in detail in reference with the accompanying figures.

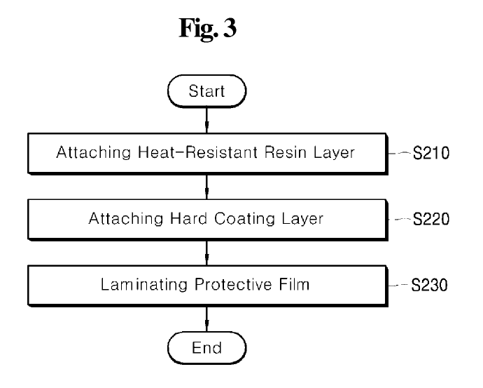

FIG. 3 is a process flow chart showing illustrating a method for manufacturing high strength transparent plastic sheet in accordance with an embodiment of the present invention.

Referring to FIG. 3, illustrated method for manufacturing high strength transparent plastic sheet may comprise attaching heat-resistant resin layer (S210), forming hard coating layer (S220), and laminating protective film (S230).

Attaching Heat-Resistant Resin

In attaching heat-resistant resin layer step (S210), each of the first and the second heat-resistant layers is formed. On the other hand, the first and the second heat-resistant resin layers may be coextruded on both sides of a transparent substrate layer with the first and the second adhesive layers. On the other hand, as described before, the first and the second adhesive layers are formed on both sides of the transparent substrate layer beforehand, the first and the second heat-resistant resin layers are extrusion coated on both sides of the first and the second adhesive layers during separate processes.

A transparent substrate layer may comprise one or more elements selected from polyethylene terephthalate (PET), polyethylene terephthalate glycol (PETG), cyclo-olefin polymer (COP), cyclo-olefin copolymer (COC), and polyethylene naphthalate (PEN).

It is preferable for each of the first and the second heat-resistant resin layers (130, 132) to have polymethyl methacrylate (PMMA) with weight-average molecular weight of 100,000˜200,000 as its main component, and using components composed of acrylic resin with glass transition temperature of 120˜130 degrees.

Forming Hard Coating Layer

In the forming the hard coating layer step (S220), each of the first and the second hard coating layers is formed on the outer surfaces of the first and the second heat-resistant resin layers. These first and second hard coating layers may be formed by applying a uniform thickness of the hard coating liquid on the first and the second heat-resistant layers for improving surface hardness, and then drying for 10˜60 minutes in about 40˜80° C.

When drying temperature is below 40° C., or drying time is less than 10 minutes, insufficient drying may occur. On the contrary, when drying temperature is over 80° C., or drying time is more than 60 minutes, shape of the product may be deformed due to excessive drying temperatures and time.

Here, each of the first and the second hard coating layers (140, 142) may use at least one selected from acrylic, urethane, epoxy, and siloxane based polymeric materials, and also ultra violet ray curable resin such as an oligomer. Also, the first and the second hard coating layers (140, 142) may further comprise silica fillers to improve strength.

Laminating Protective Film

In the laminating protective film step (S230), the first and the second protective films are laminated on the first and the second hard coating layers.

In this instance, the first and the second protective films (150, 152) are release films formed to protect sheet surfaces from dust, foreign objects, etc., and are used delaminated when used in outer window of portable display devices.

These first and second protective films (150, 152) may use one or more of the elements selected from polyethylene resin, polyolefine resin, polybutylene terephthalate resin, polyethylene terephthalate resin, polyethylene naphthalate resin, polyetherimide resin, acetate resin, polystyrene resin, vinyl chloride resin, etc.

In this instance, laminating protective film step (S230) is not necessarily performed, and may be skipped if necessary.

And thus, a method for manufacturing high strength transparent plastic sheet in accordance with an embodiment of the present invention may end.

As observed until now, a high strength transparent plastic sheet manufactured from the described process (S210˜S230) not only has benefits of having impact resistance and resistance to high temperature and high humidity, but also being relatively lighter and having remarkably low manufacturing costs compared to glass substrates.

Therefore, since it is possible for a high strength transparent plastic sheet in accordance with the present invention to possess excellent mechanical and optical physical properties while based on plastic materials, it is suitable for outer window applications of portable display devices such as cellular phones, smart phones, PDA (personal digital assistants), tablet PC (tablet personal computer), etc.

### EXAMPLES

Hereinafter, configurations and effects of the invention will be explained in more detail by means of preferred examples of the present invention. But, it should be understood that the examples are presented as a preferred example of the present invention, and the present invention is not limited to the following examples.

Contents not written here may be fully inferred by those skilled in the art, and thus the description is skipped.

1. Producing Specimens

### Example 1

On both sides of polyethylene terephthalate (PET) film with a thickness of 50 μm, polyurethane adhesive with a thickness 2 μm is applied after drying by gravure coating method, and through a separate extrusion process, acrylic copolymer heat-resistant resin with glass transition temperature of 125 degrees is coextrusion coated on both sides of polyethylene terephthalate (PET) film using a T-die method. Total thickness of the coextrusion is produced to 1 mm.

And then, urethane polymer is applied, as a hard coating layer, with a thickness of 5 μm to each side of the hard coating layer of the coextruded sheet, and hardened for 15 minutes at 50° C., and then cut to 3 cm(horizontal)*3 cm(vertical)*1 mm(thickness) to produce a transparent plastic sheet specimen.

### Example 2

Except for using PETG film instead of PET film, a transparent plastic sheet specimen was produced with an identical method with example 1.

### Example 3

Except for using composite film composed of 60 weight % of PETG and 40 weight % of cyclo-olefin polymer instead of PET film, a transparent plastic sheet specimen was produced with an identical method with example 1.

### Example 4

Except for using composite film composed of 80 weight % of PET and 20 weight % of polyethylene naphthalate (PEN), a transparent plastic sheet specimen was produced with an identical method with example 1.

### Example 5

Except for using ethylene co-vinyl acetate (EVA) and applying with a thickness 4 μm instead of polyurethane adhesive, a transparent plastic sheet specimen was produced with an identical method with example 1.

### Example 6

Except for using siloxane polymer and applying with a thickness 5 μm to each side instead of urethane polymer for hard coating, a transparent plastic sheet specimen was produced with an identical method with example 1.

### Comparative Example 1

Gorilla Glass, which is commercially used for outer window of portable display devices, of Corning is cut to 3 cm(horizontal)*3 cm(vertical)*1 mm(thickness) to produce a hardened glass specimen.

### Comparative Example 2

Polycarbonate (PC) film with a thickness of 0.6 mm and PMMA film with a thickness of 0.4 mm is coextruded by T-die method, and then cut to 3 cm(horizontal)*3 cm(vertical)*1 mm(thickness) to produce a transparent plastic sheet specimen.

### Comparative Example 3

Polymethyl methacrylate (PMMA) film with a thickness of 1 mm is extruded to a single layer by T-die method, and then cut to 3 cm(horizontal)*3 cm(vertical)*1 mm(thickness) to produce a transparent plastic sheet specimen.

### Comparative Example 4

Except for using acrylic copolymer heat-resistant resin with glass transition temperature of 100, a transparent plastic sheet specimen was produced with an identical method with example 1.

2. Physical Properties Evaluation

Table 1 illustrates physical properties result of specimens according to examples 1˜6, and Table 2 illustrates physical properties result of specimens according to comparative examples 1˜4.

(1) Permeability (%) and haze: measured with a Hazemeter based on ASTM D1003.

(2) B*: measured with SHIMAZU UV-VIS-NIR spectrophotometer (UV-3600).

(3) Flexural modulus (MPa): measured based on ASTM D790.

(4) Surface pencil hardness: measured with a 1 kg load based on ASTM D1003.

(5) Drop test: A steel ball of 13.2 g is dropped 5 times from a fixed height to measure the height where the specimen cracks for the drop test, the maximum height each specimen endured without cracking is illustrated in Table 1.

TABLE 1

| | Exam- | Exam- | Exam- | Exam- | Exam- | Exam- |
|---|---|---|---|---|---|---|
| | ple | ple | ple | ple | ple | ple |
| Classification | 1 | 2 | 3 | 4 | 5 | 6 |
| Thickness | 1.0 | 1.0 | 1.0 | 1.0 | 1.0 | 1.0 |
| (mm) | | | | | | |
| Permeability | 93.0 | 93.6 | 92.5 | 93.1 | 93.5 | 92.6 |
| (%) | | | | | | |
| Haze | 0.3 | 0.3 | 0.3 | 0.3 | 0.3 | 0.3 |
| b* | 0.30 | 0.32 | 0.31 | 0.30 | 0.30 | 0.31 |
| Flexural | 10,000 | 10,000 | 10,000 | 9,800 | 9,600 | 10,000 |
| modulus (MPa) | | | | | | |
| Surface pencil | 6 H | 6 H | 6 H | 5 H | 6 H | 5 H |
| hardness | | | | | | |
| Maximum drop | 80 | 81 | 79 | 78 | 78 | 79 |
| height (cm) | | | | | | |

TABLE 1

| | Comparative | Comparative | Comparative | Comparative |
|---|---|---|---|---|
| Classification | Example 1 | Example 2 | Example 3 | Example 4 |
| Thickness | 1.0 | 1.0 | 1.0 | 1.0 |
| (mm) | | | | |
| Permeability | 93.0 | 91.7 | 92.3 | 91.0 |
| (%) | | | | |
| Haze | 0.1 | 0.13 | 0.15 | 0.6 |
| b* | 0.50 | 0.53 | 0.49 | 0.18 |
| Flexural | 120,000 | 5,500 | 5,300 | 9,700 |
| modulus (MPa) | | | | |
| Surface pencil | 9H | 4H | 3H | 7H |
| hardness | | | | |
| Maximum drop | 112 | 23 | 22 | 84 |
| height (cm) | | | | |

Referring to Table 1 and Table 2, in the case of specimens according to examples 1˜6, it can be observed that values of permeability, haze, and b* do not show much difference in physical properties from specimen according to comparative example 1. Also, in the case of specimens according to examples 1˜6, flexural modulus and surface pencil strength is 9,600˜10,000 and 5 H˜6 H, and values fall short of the physical property values from specimen according comparative example 1, but it can be observed that it is a higher value than that of comparative examples 2˜3. Especially, in the case of specimens according to examples 1˜6, maximum drop height is 78˜80 cm from drop tests and it can be observed that it is close to comparative example 1.

Meanwhile, in the case of specimens according to comparative examples 2˜3 comparing to examples 1˜6, permeability and haze have similar values, but it can be observed that b* value is measured at a very high value. Also, in the case of specimens according to comparative examples 2˜3, it can be observed that they have very low flexural modulus and surface pencil strength values compared to specimens according to examples 1˜6. Especially, in the case of specimens according to comparative examples 2˜3, maximum drop height of only 22˜23 cm from the drop test is observed.

Also, in the case of specimens according to comparative example 4, most of the physical values are similar to the physical values of specimens according to examples 1˜6, but haze sharply worsening is observed.

As can be seen from the experiment results above, if specimens according to examples 1˜6 is used for outer window of portable display devices, characteristics coming close to mechanical and optical physical properties of hardened glass substrates may be implemented with light weight and low cost is observed.

Although some exemplary embodiments have been described herein, it should be understood by those skilled in the art that these embodiments are given by way of illustration only, and that various modifications, variations and alterations can be made without departing from the spirit and scope of the invention. The scope of the present invention should be defined by the appended claims and equivalents thereof.

1. A high strength transparent plastic sheet comprising:
a transparent substrate layer;
a first and a second adhesive layers respectively formed on both sides of the transparent substrate layer;
a first and a second heat-resistant resin layers respectively formed on outer surfaces of the first and second coating layers; and
a first and a second hard coating layers respectively formed on outer surfaces of the first and the second resin layers.

2. A high strength transparent plastic sheet according to claim 1, wherein the transparent substrate layer comprises at least one selected from polyethylene terephthalate (PET), polyethylene terephthalate glycol (PETG), cyclo-olefin polymer (COP), cyclo-olefin copolymer (COC), and polyethylene naphthalate (PEN).

3. A high strength transparent plastic sheet according to claim 1, wherein each of the first and the second adhesive layers uses one adhesive selected from polyester, polyurethane, ethylene co-vinyl acetate, and polyvinyl acetate (PVAc).

4. A high strength transparent plastic sheet according to claim 1, wherein each of the first and the second adhesive layers has thickness of 0.5˜2 μm.

5. A high strength transparent plastic sheet according to claim 1, wherein each of the first and the second heat-resistant resin layers has polymethyl methacrylate (PMMA) with weight-average molecular weight of 100,000˜200,000 as its main component.

6. A high strength transparent plastic sheet according to claim 1, wherein each of the first and the second heat-resistant resin layers is formed with acrylic resin with glass transition temperature of 120˜130 degrees.

7. A high strength transparent plastic sheet according to claim 1, wherein each of the first and the second hard coating layers comprises at least one selected from ultra violet ray curable resins and oligomers comprising acryl, urethane, epoxy, and siloxane.

8. A high strength transparent plastic sheet according to claim 1, wherein each of the first and the second coating layers has thickness of 2˜7 μm.

9. A method for manufacturing high strength transparent plastic sheet comprising:
(a) attaching first and second adhesive layers and first and second resin layers in order respectively to a transparent substrate layer; and
(b) forming first and second hard coating layers respectively on outer surfaces of the first and the second heat-resistant resin layers.

10. A method for manufacturing high strength transparent plastic sheet according to claim 9, wherein during the step (a), the first and the second adhesive layers are formed on both sides of the transparent substrate layer in advance, and, subseqently, the first and the second heat-resistant resin layers are extrusion coated on both sides thereof, or the first and the second adhesive layers and the first and the second heat-resistant resin layers are coextrusion coated on both sides of the transparent substrate layer.

11. A method for manufacturing high strength transparent plastic sheet according to claim 9, wherein each of the first and the second heat-resistant reinforcing resin layers has polymethyl methacrylate (PMMA) with weight-average molecular weight of 100,000˜200,000 as its main component.

12. A method for manufacturing high strength transparent plastic sheet according to claim 9, wherein each of the first and second heat-resistant resin layers is formed with acrylic resin with glass transition temperature of 120˜130 degrees.

13. A method for manufacturing high strength transparent plastic sheet according to claim 9, wherein after (b), further comprises,
(c) laminating first and second protective films on the first and the second hard coating layers.
